(19) United States
(12) Patent Application Publication
(10) Pub. No.: US 2011/0032339 A1
(43) Pub. Date: Feb. 10, 2011

(54) THREE-DIMENSIONAL IMAGE DISPLAY METHOD AND APPARATUS

(75) Inventors: Yuzo Hirayama, Kanagawa-Ken (JP); Yoshiyuki Kokojima, Kanagawa-Ken (JP); Hitoshi Kobayashi, Kanagawa-Ken (JP); Rieko Fukushima, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA, Tokyo (JP)

(21) Appl. No.: 12/811,057

(22) PCT Filed: Feb. 27, 2009
(86) PCT No.: PCT/JP2009/054226

§ 371 Date: Oct. 26, 2010

(30) Foreign Application Priority Data
Mar. 27, 2008 (JP) 2008-083723

(51) Int. Cl. H04N 13/04

(52) U.S. Cl. 348/51; 348/E13.026

(57) ABSTRACT

It is made possible to mitigate appearance of the strap-shaped disturbance image and shift to the side lobe naturally. The sense of incongruity for an image viewed in a transitional zone is reduced by performing interpolation processing between parallax information pieces displayed on pixels associated with adjacent exit pupils.

### BACKGROUND OF THE INVENTION

1. Field of the Invention

The present invention relates to a three-dimensional image display method, and apparatus, using a multi-viewpoint image.

2. Related Art

As three-dimensional image display apparatuses (auto three-dimensional image display apparatuses) which make it possible to view a three-dimensional image without glasses, the multiview system, the dense multiview system, the integral imaging system (II system), and the one-dimensional II system (1D-II system: parallax information is displayed only in the horizontal direction) systems are known. These have a common structure that exit pupils represented by a lens array are disposed on a front face of a flat panel display (FPD) represented by a liquid crystal display device (LCD). The exit pupils are disposed at constant intervals, and a plurality of FPD pixels are assigned to each exit pupil. In the present description, a pixel group assigned to each exit pupil is referred to as pixel group. The exit pupil corresponds to a pixel of the three-dimensional image display apparatus, and a pixel seen via the exit pupil is changed over according to the viewing location. In other words, the exit pupil behaves as a three-dimensional image displaying pixel which changes in pixel information according to the viewing location.

In the three-dimensional image display apparatus having such a configuration, pixels on the FPD are finite. Therefore, there is a limitation in the number of pixels forming the pixel group as well. (For example, there are pixels in the range of 2 to 64 pixels per direction. Especially the case of two pixels is referred to as binocular.) Therefore, it cannot be avoided that the range (viewing zone) in which a three-dimensional image can be viewed is limited. In addition, if a deviation from the viewing zone to the left or right occurs, it cannot be avoided to view a pixel group corresponding to an adjacent exit pupil. Since light ray viewed by a viewer is a three-dimensional image formed by light rays passed through an exit pupil adjacent to the corresponding to the exit pupil, the light ray direction does not coincide with parallax information and distortion is contained. Since the parallax image is changed over according to a movement of the viewing location, however, this is also seen as a three-dimensional image. In some cases, therefore, a zone where the three-dimensional image containing the distortion is seen is called side lobe. However, it is known that a quasi image (an image inverted in unevenness) is seen in a transitional zone from a proper viewing zone to the side lobe because parallax images at both ends of a pixel group are laterally inverted and seen.

Heretofore as well, several methods for preventing the quasi image have been proposed. First, a method of providing a wall physically at a pixel group boundary and thereby making adjacent pixel groups invisible is known (for example, see JP-A 2001-215444). Furthermore, a method of detecting the location of a viewer and re-setting pixel groups corresponding to exit pupils so as to bring the location of the viewer into the viewing zone is known (for example, see JP-A 2002-344998).

A technique of taking care of informing the viewer that the side lobe is not a proper image by displaying some warning image in a transitional zone from the viewing zone to a side lobe so as to be sensible although the sense of incongruity cannot be reduced is known (for example, see JP-B 3788974).

On the other hand, a method of controlling the viewing zone of the auto three-dimensional image display apparatus by adjusting the number of pixels included in pixel groups assigned to exit pupils is known (for example, see JP-B 3892808).

According to the technique described in JP-B 3892808, the number of pixels included in pixel groups is set equal to two values: n and (n+1) (where n is a natural number of at least 2, and the appearance frequency of pixel groups having (n+1) pixels is controlled. It has been made clear that a strap-shaped disturbance image occurs besides the quasi image when the technique described in JP-B 3892808 is used.

### SUMMARY OF THE INVENTION

The present invention has been made in view of these circumstances, and an object of thereof is to provide a three-dimensional image display method, and apparatus, which mitigates the appearance of the strap-shaped disturbance image and makes it possible to shift to a side lobe naturally.

According to an aspect of the present invention, there is provided a three-dimensional image display method for displaying a three-dimensional image on a display apparatus including a plane image display having pixels arranged in a matrix form, and an optical plate disposed so as to be opposed to the plane image display, the optical plate having exit pupils arranged in at least one direction to control light arrays from the pixels, the method comprising: generating an image for three-dimensional image display in which a plurality of pixels in the plane image display are associated as one of pixel groups with each exit pupil; setting each of the pixel groups to either a first pixel group which is n (where n is a natural number of at least 2) in the number of pixels in one direction of the pixel group or a second pixel group which is (n+1) in the number of pixels in one direction of the pixel group; disposing the second pixel groups between the first pixel groups discretely and at substantially constant intervals; and performing interpolation processing to mutually mix parallax information pieces of pixels located at both ends of the second pixel groups.

According to another aspect of the present invention, there is provided a three-dimensional image display apparatus including: a plane image display having pixels arranged in a matrix form; an optical plate disposed so as to be opposed to the plane image display, the optical plate having exit pupils arranged in at least one direction to control light arrays from the pixels, a plurality of pixels in the plane image display being associated as one of pixel groups with each exit pupil; a setting unit setting each of the pixel groups to either a first pixel group which is n (where n is a natural number of at least 2) in the number of pixels in one direction of the pixel group or a second pixel group which is (n+1) in the number of pixels in one direction of the pixel group; a disposition unit disposing the second pixel groups between the first pixel groups discretely and at substantially constant intervals; and an interpolation processor performing interpolation processing to mutually mix parallax information pieces of pixels located at both ends of the second pixel groups.

### BRIEF DESCRIPTION OF THE DRAWINGS

FIGS. 1(a) to 1(d) are diagrams showing a three-dimensional image display apparatus;

FIGS. 2(a) and 2(b) are diagrams for explaining a multiview system three-dimensional image display apparatus;

FIG. 3 is a diagram for explaining a multiview system three-dimensional image display apparatus;

FIGS. 4(a) to 4(j) are diagrams for explaining a multiview system three-dimensional image display apparatus;

FIG. 5 is a diagram for explaining an II system three-dimensional image display apparatus;

FIGS. 6(a) to 6(b) are diagrams for explaining an II system three-dimensional image display apparatus;

FIGS. 7(a) to 7(j) are diagrams for explaining an II system three-dimensional image display apparatus;

FIG. 8 is a diagram showing a viewing distance and the number of times of parallax image number changeover on a display face;

FIG. 9 is a concept diagram for explaining relations between pixel groups and pixels subject to processing according to an embodiment at the time when viewing zone optimization is applied;

FIG. 10 is a diagram showing tile images for displaying a multiview system three-dimensional image;

FIG. 11 is a diagram showing tile images for displaying an II system three-dimensional image;

FIG. 12 is a block diagram showing general image data processing of an II system three-dimensional image display apparatus;

FIG. 13 is a flow chart showing general image data processing of the II system three-dimensional image display apparatus;

FIG. 14 is a block diagram showing image data processing according to a first example;

FIG. 15 is a flow chart showing image data processing according to the first example;

FIG. 16 is a block diagram showing an interpolation processor according to the first example;

FIG. 17 is a diagram showing an example of pin assignment based on SPWG according to the first example;

FIG. 18 is a block diagram showing image data processing according to a second example;

FIG. 19 is a flow chart showing image data processing according to the second example;

FIG. 20 is a block diagram showing image data processing according to a third example;

FIG. 21 is a flow chart showing image data processing according to the third example;

FIG. 22 is a block diagram showing image data processing according to a fourth example;

FIG. 23 is a flow chart showing image data processing according to the fourth example; and

FIG. 24 is a block diagram showing image data processing according to a fifth example.

### DETAILED DESCRIPTION OF THE INVENTION

Prior to description of embodiments of the present invention, a difference between the II system and the multiview system and viewing zone optimization will now be described. Mainly one-dimension will be described because its description is easy. However, the present invention can be applied to two-dimension. Directions such as up, down, left, right, length and breadth in the ensuing description mean relative directions with the pitch direction of following exit pupils being defined as the breadth direction. Therefore, they do not necessarily coincide with absolute up, down, left, right, length and breadth directions obtained when the gravity direction in the real space is defined as the down direction.

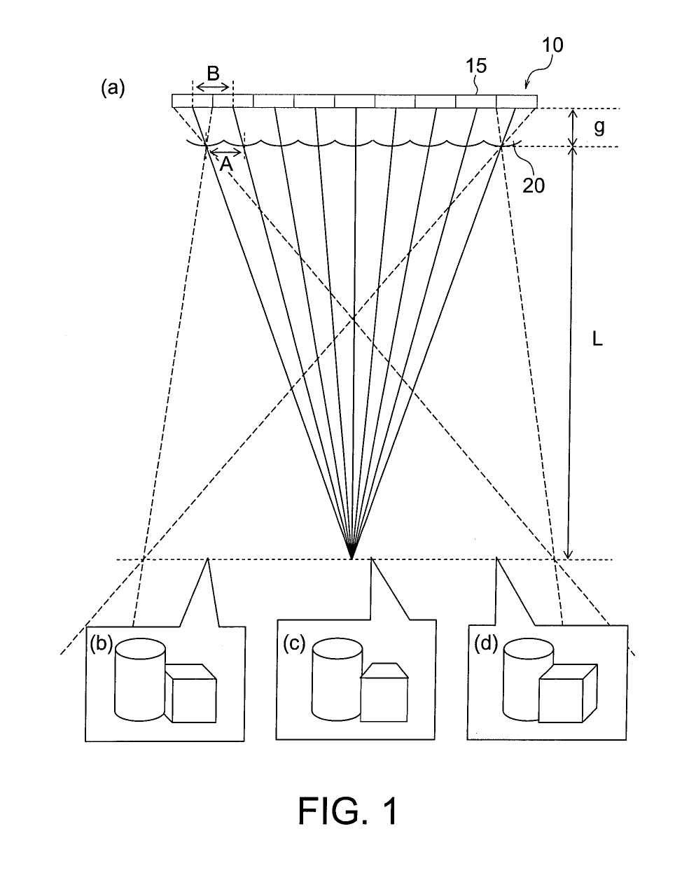

A horizontal section view of an auto three-dimensional image display apparatus is shown in FIG. 1(a). The three-dimensional image display apparatus includes a plane image display 10 and exit pupils 20. The plane image display 10 includes pixels arranged in the length direction and the breadth direction so as form a matrix, as in, for example, a liquid crystal display panel. The exit pupils 20 are formed of, for example, lenses or slits, and they are also called optical plates for controlling light rays from the pixels. FIG. 1(a) is a horizontal sectional view showing position relations between the exit pupils 20 and pixel groups 15 in the plane image display 10. For light ray groups from all exit pupils 20 to overlap at a finite distance L from the exit pupils 20, the following equation should be satisfied

A=B×L/(L+g) (1)

where A is a pitch of the exit pupils, B is an average width pitch of pixel groups associated with one of the exit pupils, and a distance (gap) between the exit pupils 20 and the plane display device 10.

A multiview or dense multiview three-dimensional image display apparatus, which is an extension of the binocular three-dimensional image display apparatus, is designed so as to cause light ray groups which have exited from all exit pupils to incident on the same area at a location of a finite distance L from the exit pupils. Specifically, every pixel group is formed of a definite number (n) pixels and the pitch of exit pupils is made slightly narrower than the pixel group. Denoting the pixel pitch by Pp, the following equation is obtained.

B=n×Pp (2)

From Equations (1) and (2), design is performed so as to satisfy the following equation.

A=B×L/(L+g)=(n×Pp)×L/(L+g) (3)

In the present description, L is referred to as viewing zone optimization distance. A system which adopts the design according to Equation (3) is referred to as multiview system. In this multiview system, it cannot be avoided that a converging point of light rays occurs at the distance L and light rays from a natural body cannot be regenerated. This is because in the multiview system both eyes are positioned at the converging point of light rays and a stereoscopic view is obtained by binocular parallax. A distance L over which the range in which a three-dimensional image is visible becomes wider is fixed.

As a method for arbitrarily controlling the viewing distance without generating a converging point of light rays at the viewing distance with the object of reproducing light rays more resembling light rays from an actual object, there is a design method of setting the pitch of the exit pupils according to the following equation.

A=n×Pp (4)

On the other hand, it is possible to satisfy Equation (1) by setting the number of pixels included in each pixel group at the finite distance L to two values: n and (n+1) and adjusting an occurrence frequency m (0≦m≦1) of a pixel group having (n+1) pixels. In other words, m should be determined so as to satisfy the following expression from Equations (1) and (4),

B=(L+g)/L×(n×Pp)=(n×Pp×(1−m)+(n+1)×Pp×m)

i.e.,

(L+g)/L=(1−m)+(n+1)/n×m (5)

For disposing the converging point of light rays behind the viewing distance L, design should be performed so as to cause an exit pupil pitch A to satisfy the following expression based on Equations (3) and (4)

(n×Pp)×L/(L+g)<A≦n×Pp (6)

Systems in which the converging point of light rays is prevented from occurring at the viewing distance L are generally referred to as II system in the present description. Its extreme configuration corresponds to Equation (4) in which the converging point of light rays is set to an infinitely remote point. In the II system in which the converging point of light rays occurs behind the viewing distance L, the viewing zone optimization distance is located behind the viewing distance L provided that the number of pixels included in a pixel group is set equal only to n. In the II system, therefore, a maximum viewing zone can be secured at the finite viewing distance L by setting the numbers of pixels included in pixel groups to two values: n and (n+1) and causing the average value B of the pixel group width to satisfy Equation (1). Hereafter, in the present description, securing a maximum viewing zone at the finite viewing distance L is referred to as “viewing zone optimization is applied.”

FIGS. 1(b), 1(c) and 1(d) are schematic horizontal section views showing how a three-dimensional image is seen in respective viewing locations at the viewing distance L. FIG. 1(b) shows an image seen from a right end zone at the viewing distance L. FIG. 1(c) shows an image seen from a central zone at the viewing distance L. FIG. 1(d) shows an image seen from a left end zone at the viewing distance L. Hereafter, the expression “viewing location” often appears. For simply describing phenomena, the location is described as a single point. This point corresponds to viewing with a single eye or a state in which an image is picked up with a single camera. As for the case where a person views with both eyes, it should be considered that the person views images having a parallax corresponding to the difference of the spacing location from two points set to the spacing between eyes.

How a parallax image is seen is different according to whether the system is the multiview system or the II system. Hereafter, this will be described.

### (Multiview System)

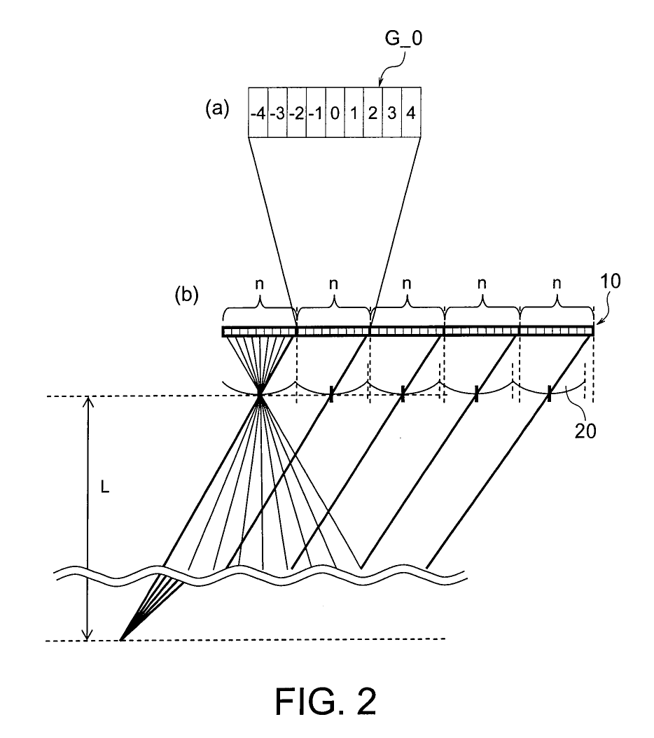

For the purpose of comparison, the multiview system will first be described. In the multiview system, a converging point of light rays is generated at the viewing zone optimization distance L as heretofore described. FIGS. 2(a) and 2(b) show horizontal sections of a multiview three-dimensional image display apparatus in the case of nine parallaxes. FIG. 2(a) shows pixel groups provided with parallax image numbers. FIG. 2(b) shows locations of incidence of straight lines drawn from the location of the viewing distance L to respective exit pupils on the pixel groups. As shown in FIG. 2(a), the number of pixels included in a pixel group (G_0) associated with one of the exit pupils 20 is nine. Parallax images provided with numbers −4 to 4 are displayed. Light rays emitted from the right end pixel having the parallax image number 4 and passed through an exit pupil 20 are converged at the distance L. Stated reversely, viewing at the viewing zone optimization distance L, a pixel which displays the same parallax image number among pixels included in the pixel group (G_0) is expanded by the exit pupil 20 and seen.

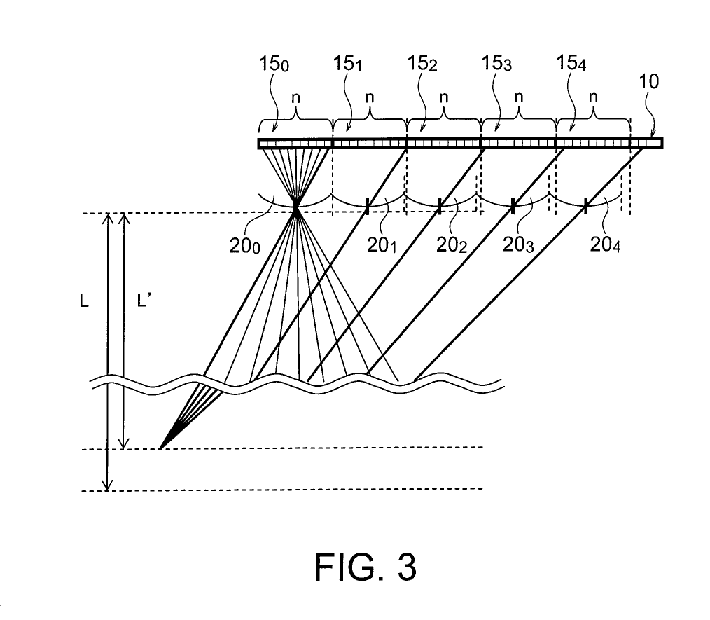

FIG. 3 shows a horizontal section of the multiview three-dimensional image display apparatus in the case where the viewing distance L′ has become shorter than the viewing zone optimization distance L (L′<L). If the viewing distance L′ has become shorter than the viewing zone optimization distance L, then the change of inclination of a straight line which extends from the viewing location through the exit pupil 20 becomes large and consequently the parallax image number expanded by the exit pupil 20 changes continuously in the screen. As for leftmost pixel group 15₀ in FIG. 3, a rightmost pixel in the pixel group 15₀ associated with an exit pupil 20₀ passed through is seen. As for a pixel group 15₁ located on the right side of the leftmost pixel group 15₀, however, a boundary between a right end pixel in the pixel group 15₁ associated with G_0 for an exit pupil 20₁ passed through and a left end pixel in an adjacent pixel group 15₂ associated with G_1 for the exit pupil 20₁ and associated with G_0 for an exit pupil 20₂ is seen. As for 15₂, 15₃ and 15₄, a situation in which left end pixels in pixel groups (G_1) adjacent to the pixel groups 15₂, 15₃ and 15₄, associated with G_0 for exit pupils 20₂, 20₃ and 20₄ passed through, respectively, is shown. For example, the pixel group 15₃ located on the right of the pixel group 15₂ so as to be adjacent thereto corresponds to G_0 for the exit pupil 20₃ located on the right of the exit pupil 20₂ through which the pixel group 15₂ has passed so as to be adjacent thereto.

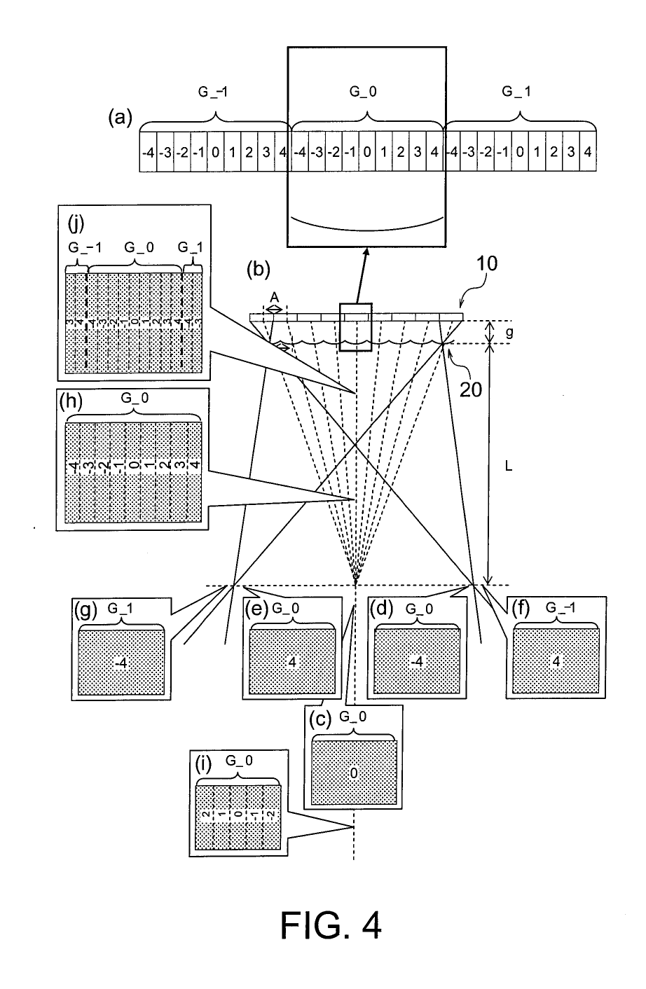

FIGS. 4(a) to 4(j) show a viewing location and parallax information which forms a display face of the three-dimensional image display apparatus viewed from the location. FIG. 4(a) is a diagram showing pixel groups provided with parallax image numbers. FIG. 4(b) shows a relation between a pixel group average pitch (A) and an exit pupil pitch (B). FIG. 4(c) to FIG. 4(g) are diagrams showing parallax image numbers viewed at the viewing distance L. FIG. 4(h) to FIG. 4(j) are diagrams showing parallax image numbers viewed when viewing at a distance deviated from the viewing distance L. If viewing is performed from the center of the viewing zone width at the distance L, then a pixel viewed over all exit pupils 20 becomes a pixel located at the center of the associated pixel group (G_0) and consequently the viewed parallax image number becomes 0 (FIG. 4(c)). If viewing is performed from the right end of the viewing zone, then a pixel viewed over all exit pupils 20 becomes a pixel located at the left end of the associated pixel group (G_0) and consequently the viewed parallax image number becomes −4 (FIG. 4(d)). If viewing is performed from the left end of the viewing zone width, then a pixel viewed over all exit pupils 20 becomes a pixel located at the right end of the associated pixel group (G_0) and consequently the viewed parallax image number becomes 4 (FIG. 4(e)). In this way, nine parallax images are changed over to be seen. By viewing these parallax images with both eyes, eight three-dimensional images shown in FIG. 1(b) to FIG. 1(c) are seen with changeover seven times. In addition, if viewing is performed beyond the right viewing zone boundary, then a pixel viewed over all the exit pupils 20 becomes a right end pixel not in the associated pixel group (G_0) but in a pixel group (G_{—}−1) which is located on the left of the pixel group (G_0) so as to be adjacent thereto and consequently the viewed parallax image number becomes 4 which belongs to G_{—}−1 (FIG. 4(f)). If the parallax image number 4 in G_{—}−1 is viewed with a right eye and the parallax image number −4 in G_0 is viewed with a left eye, then pseudoscopy, i.e., a quasi image inverted in unevenness is viewed. If further movement to the right is performed, then the parallax image is changed over so as to become 3, 2, 1, . . . in parallax image number, and stereoscopic view also becomes possible. However, the display location shifts by one exit pupil, and the breadth width of the screen viewed from the viewing location appears to be narrow as compared with when viewed from a proper viewing location in the viewing zone.

As a result, a three-dimensional image which is long in length. An image which has become long in length according to a change of the screen width is frequently seen in two-dimensional images. Therefore, the viewer is hard to be conscious of distortion. In general, therefore, a viewing range of a three-dimensional image containing these distortions is called side lobe. This is included in the viewing range in some cases. Also in the case where movement to the left is performed, a symmetric change is caused. However, description thereof will not be repeated here.

On the other hand, if the viewer moves before or behind the viewing distance L and views, the parallax image number which forms the screen changes over in the range of the same pixel group (G_0). For example, the parallax image number which forms the screen becomes the range of −4 to 4 (FIG. 4(h)) or the range of 2 to −2 (FIG. 4(i)).

In addition, if the viewing distance is extremely short or long, then it cannot be coped with in the same pixel group and pixels in adjacent pixel groups are viewed in some cases (FIG. 4(j)).

Heretofore, it has been described that the parallax image number or the pixel group changes over on the screen according to the change of the viewing distance. In the multiview system, a stereoscopic image is perceived by binocular parallax at the viewing distance L as described hereafter as well. Therefore, it is desirable that a single parallax image is seen in each of the eyes. For making the parallax information seen via an exit pupil single, the focus of, for example, a lens included in the exit pupil is narrowed down remarkably, or the opening width of a slit or a pinhole included in the exit pupil is narrowed down remarkably.

As a matter of course, the distance of the converging point of light rays is made to nearly coincide with the distance between eyes. In such a design, in a part where the viewed parallax image number, i.e., the viewed pixel changes over in the screen as described before as a result of a forward or backward slight shift from the viewing distance, a non-pixel zone located at a boundary between pixels is viewed and the luminance falls. Furthermore, changeover to an adjacent parallax number also looks discontinuous. In other words, a three-dimensional image cannot be viewed in a place other than the vicinity of the viewing zone optimization distance L.

### (II System)

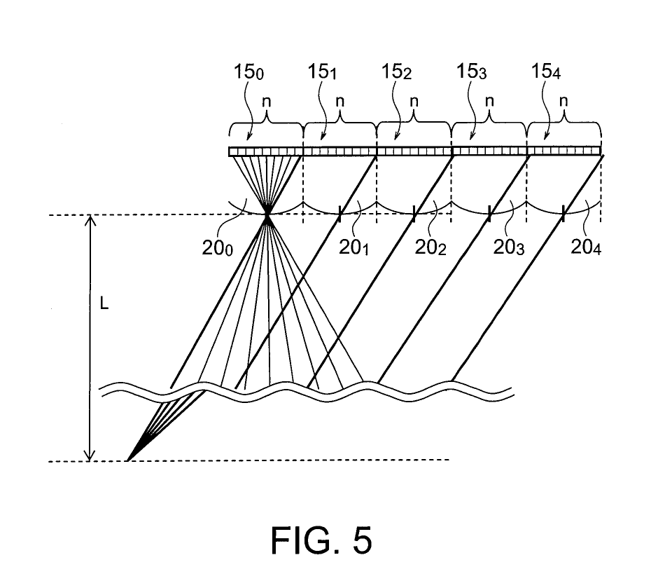

The II system relating to the stereoscopic image display apparatus according to the present embodiment will now be described. In the typical II system, the space of exit pupils is set to n times the pixel width. FIG. 5 shows a horizontal section view (partial) of an II system three-dimensional image display apparatus in the case where every pixel group is formed of n pixels, and locations of incidence of straight lines drawn from the location of the viewing distance L to respective exit pupils on the pixel groups. In the configuration of the II system shown in FIG. 5, every pixel group is formed of n pixels (it corresponds to the case where m=0 is set in Equation (5)). In the pixel group (G_0) associated with an exit pupil, a line drawn from the right end pixel in the leftmost pixel group 15₀ through an exit pupil 20₀ is incident on the left end of the viewing zone at the viewing distance L. In other words, the right end pixel in the pixel group (G_0) is viewed.

A line is drawn from this incidence location through an exit pupil 20₁ located further on the right in a perspective projection manner. As a result, information seen through the exit pupil 20₁ becomes a boundary between a right end pixel in the pixel group 15₁ associated with G_0 for the exit pupil 20₁ passed through and a left end pixel associated with G_1 for the adjacent exit pupil 20₁ and associated with G_0 for the exit pupil 20₂. In addition, information seen through the right exit pupil 20₂ becomes a left end pixel in 15₃ associated with G_1 for the exit pupil 20₂ and associated with G_0 for the exit pupil 20₃ (FIG. 5).

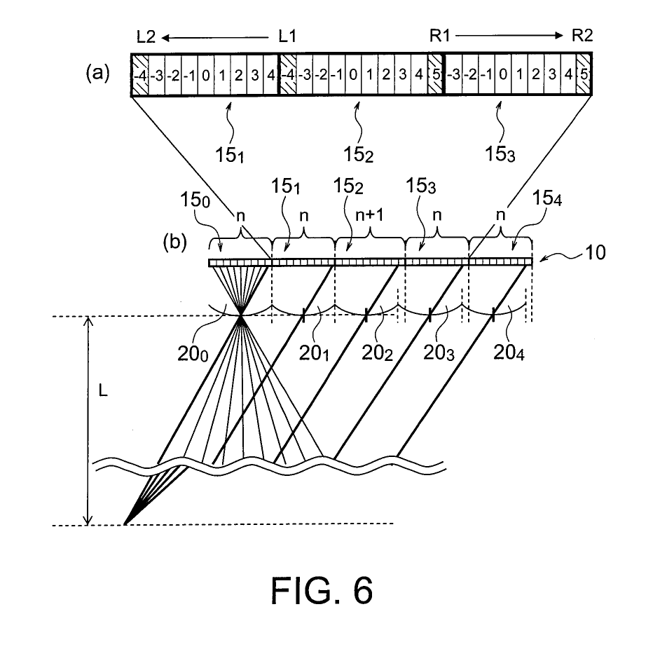

FIGS. 6(a) and 6(b) show a horizontal section view of the II system three-dimensional image display apparatus in the case where the viewing zone optimization is applied. FIG. 6(a) shows pixel groups provided with parallax image numbers. FIG. 6(b) shows locations of incidence of lines drawn from the location of the viewing distance L to respective exit pupils on the pixel groups.

In FIGS. 6(a) and 6(b), pixel groups each having (n+1) pixels are disposed discretely while keeping hardware intact. When viewing from the left end of the viewing zone at a finite distance L, it becomes possible to view parallax information displayed on right end pixels in pixel groups 15₀ to 15₄ associated with G_0 for exit pupils 20₀ to 20₄. In other words, the width in which the three-dimensional image can be viewed is maximized. The parallax image number in the II system is determined by relative locations of exit pupils and pixels, and light rays which have exited from pixels displaying parallax images provided with the same parallax image number through exit pupils become parallel. By providing the pixel group 15₂ having (n+1) pixels, therefore, relative locations of exit pupils and pixel groups are shifted by one pixel, and the parallax image number included in each pixel group changes from a range −4 to 4 to a range −3 to 5, resulting in a change of inclination of a light ray group which exits from the exit pupil (FIG. 6).

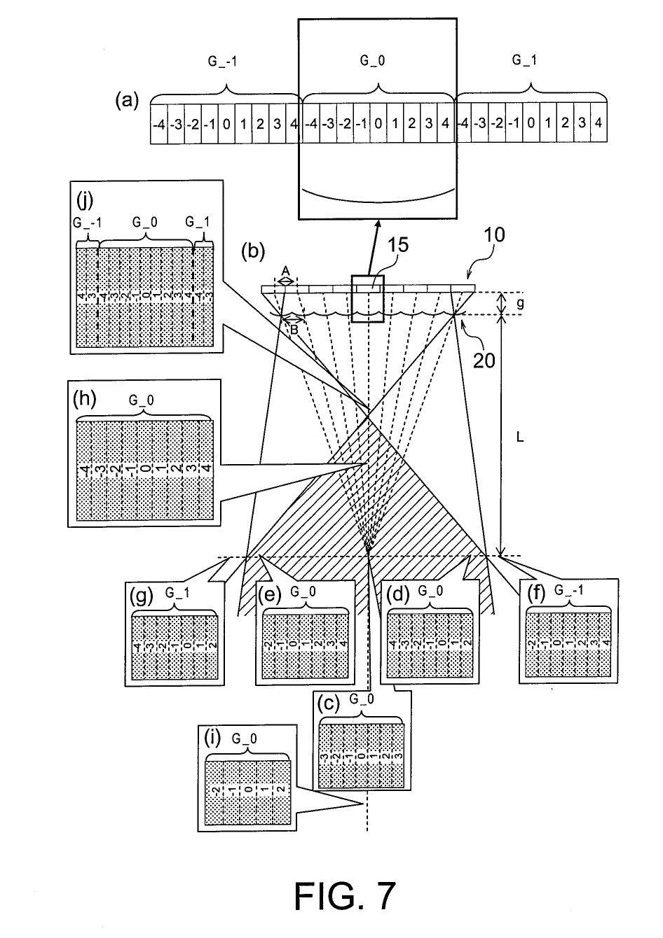

The II system is the same as the multiview system in that the viewing zone width can be maximized at the distance L. However, the II system is different from the multiview system in parallax information via the exit pupil. This situation will now be described with reference to FIGS. 7(a) to 7(j). FIG. 7(a) is a diagram showing pixel groups provided with parallax image numbers. FIG. 7(b) shows a relation between a pixel group average pitch (A) and an exit pupil pitch (B). FIG. 7(c) to FIG. 7(g) are diagrams showing parallax image numbers viewed at the viewing distance L. FIG. 7(h) to FIG. 7(j) are diagrams showing parallax image numbers viewed when viewing at a distance deviated from the viewing distance L.

In the multiview system, the parallax image number viewed through an exit pupil is single when the viewer views from the viewing zone optimization distance L. In the II system, however, the parallax image number varies in the screen. In FIG. 6, a parallax image number 4 is viewed on the left side of the pixel group having (n+1) pixels, whereas a parallax image number 5 is viewed on the right side of the pixel group having (n+1) pixels. FIGS. 7(a) to 7(j) show that parallax image numbers −3 to 3 are viewed in the screen in the center at the viewing zone optimization distance L (FIG. 7(c)), parallax image numbers −4 to 2 are viewed in the screen on the right side at the viewing zone optimization distance L (FIG. 7(d)), and parallax image numbers −2 to 4 are viewed in the screen on the left side (FIG. 7(e)). In this way, the set of viewed parallax image numbers changes according to the viewing location and they are incident on both eyes. As a result, the change of appearance shown in FIG. 1(b) to FIG. 1(c) can be realized continuously.

In this manner, in the II system, the parallax image number certainly changes over in the screen when the viewer views at a finite viewing distance. Therefore, a luminance change caused by that a pixel part or a pixel boundary part is seen via an exit pupil is not allowed. Furthermore, it is necessary to show changeover of parallax images continuously. Therefore, causing mixture presence of parallax information (making it possible to view a plurality of pieces of parallax information from a single location), i.e., crosstalk is caused positively. When changeover occurs in parallax image numbers belonging to the same pixel group (for example, G_0), the crosstalk causes the ratio between two adjacent pieces of parallax information to change continuously according to a variation of the location viewed through an exit pupil and brings about an effect like linear interpolation in the image processing. Because of presence of the crosstalk, replacement of the parallax image number in the case where the viewing distance moves forward or backward is also performed continuously. When the viewing distance is extremely short or long, replacement of the pixel group is also performed continuously. If the viewing location gets near the display face, then the change of the inclination of a line drawn from the viewing location toward the exit pupil 20 becomes large and consequently the frequency of replacement of changeover of the parallax image number increases (FIG. 7(h)). If the viewing location goes away from the display face, then conversely the frequency of parallax image number changeover decreases (FIG. 7(i)). In other words, because of presence of crosstalk, the viewer can view a three-dimensional image having a higher perspective degree provided that the viewer views at a distance shorter than the viewing zone optimization distance L (FIG. 7(h)). If the viewer views at a distance longer than the viewing zone optimization distance L, the viewer can view a three-dimensional image having a lower perspective degree continuously without a sense of incongruity (FIG. 7(i)). In other words, the change of the perspective projection degree caused by a variation of the viewing distance can be reproduced, and this is nothing but that light rays from a real object can be reproduced in the II system. As a result, it can be said that a shaded zone in FIG. 7(b) is a viewing zone where the three-dimensional video image is changed over continuously.

If the viewer views beyond the viewing zone boundary in the II system, then a pixel viewed over every lens is associated with a pixel group G_{—}−1 (FIG. 7(f)) or associated with a pixel group G_1 (FIG. 7(g)). In other words, display is performed with a shift of only one exit pupil, but a three-dimensional image is viewed. Since distortion of the image is equivalent to that in the multiview system, its description will not be repeated here.

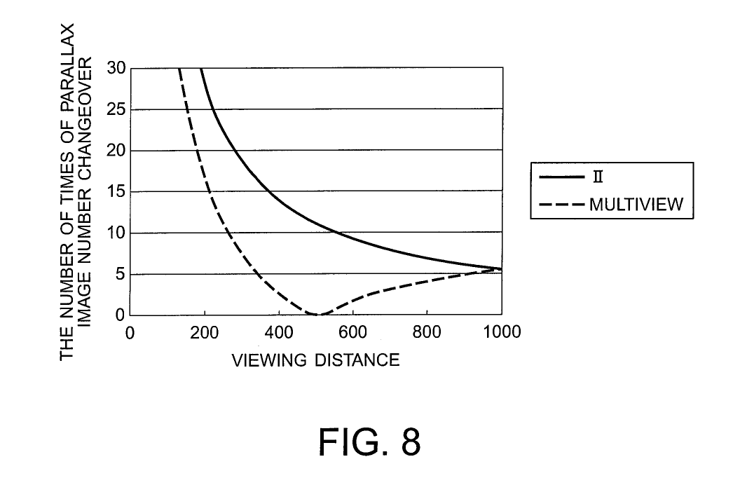

FIG. 8 shows the viewing distance and the frequency of parallax image number changeover in the multiview system and the II system. A difference between the multiview system and the II system in the present description will now be described supposing that crosstalk is present in both systems. In the multiview system, parallax images having the same number are included in the screen when viewed from one point at the viewing zone optimization distance L. In the II system, the parallax image number is changed over in the screen when viewed from the viewing zone optimization distance L.

Heretofore, changeover of the viewing location and parallax image number in the multiview system and the II system has been described. At a viewing zone boundary of the II system, a parallax image which is the origin of pseudoscopy is seen as a double image by the pseudoscopy or crosstalk, and in addition a strap-shaped disturbance image is generated. This phenomenon will now be described with reference to FIG. 6.

### (Description of Strap-Shaped Disturbance Image Characteristic to II)

It has already been described that there is crosstalk in the II system. A disturbance image viewed at the viewing zone boundary will now be described with due regard to crosstalk with reference to FIGS. 6(a) and 6(b). In a leftmost pixel group 15₀, a center of a pixel which displays information of a parallax image number 4 is viewed. In a pixel group 15₁ located on the right side of the pixel group 15₀, however, a part located further on the right of the pixel which displays information of the parallax image number 4 is viewed. In other words, an image which displays information of a parallax image number −4 in a pixel group 15₂ located further on the right side becomes seen concurrently. In the configuration shown in FIG. 5, the ratio at which the parallax image number 4 is seen gradually decreases whereas the ratio at which the parallax image number −4 is seen gradually increases as the pixel group shifts to the right. Densities of a first image (for example, the parallax image number 4) and a second image (for example, the parallax image number −4) of the double image changes over continuously. In the configuration subjected to the viewing zone optimization processing shown in FIG. 6, the pixel group 15₂ having (n+1) pixels in the center is provided and consequently information which has had a parallax image number −4 until then is changed over to a parallax image number 5. In other words, in a place where the density of the first image decreased and the density of the second image increased, the density of the first image increases discontinuously. Since this discontinuous density change occurs in a location of formation of the pixel group 15₂ having (n+1) pixels, it occurs at equal intervals in the screen and gives a strong unnatural impression. This density change occurs as a vertical line in the one-dimensional II system and as a grating in the two-dimensional II system.

These problems are solved by a three-dimensional image display apparatus according to an embodiment of the present invention.

Hereafter, the three-dimensional image display apparatus according to the present embodiment will be described.

### Embodiment

The three-dimensional image display apparatus according to the present embodiment performs image processing which implements reduction of the sense of incongruity for the disturbance image viewed at the viewing zone boundary in the II system. This image processing will now be described with reference to FIG. 6. Since the pixel group having (n+1) pixels is generated, an image of a parallax image number 5 is displayed on a pixel which has displayed an image of a parallax image number −4 conventionally. Since this change is discontinuous, it is visually regarded as a disturbance image. The discontinuous change which is the cause of the disturbance image is mitigated by mixing parallax image information pieces (parallax image numbers −4 and 5 represented by shaded zones in FIG. 6) on both sides of the pixel group 15₂ having (n+1) pixels into each other at a definite ratio. In addition, in FIG. 6, pixels which display the parallax image number −4 are provided with numbers L1, L2, . . . in order of advancing to the left side from a pixel belonging to the pixel group 15₂ having (n+1) pixels. Pixels which display the parallax image number 5 are provided with numbers R1, R2, . . . in order of advancing to the right side from a pixel belonging to the pixel group 15₂ having (n+1) pixels. Denoting the number of pixels (unidirectional) to be subjected to image processing according to the present embodiment by x, the number x of pixels to be subjected to processing need not be 1 in this processing.

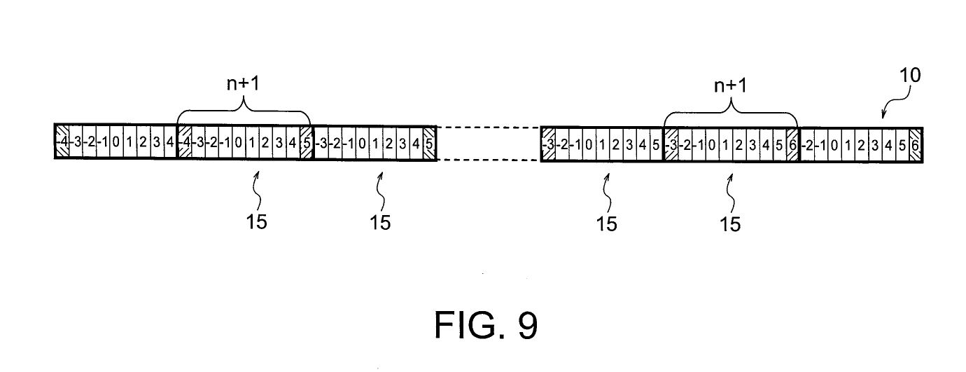

In the multiview system, viewing zones of all exit pupils completely overlap each other at the viewing distance. For example, if the number of parallaxes is nine, a viewing zone corresponding to nine parallaxes is implemented. On the other hand, in the case of the II system, pixel locations associated with exit pupils are periodic (ideally constant). Therefore, viewing zones of adjacent exit pupils deviate by the exit pupil pitch. When the quantity of the deviation corresponds to one parallax of the viewing zone width at the viewing distance, a viewing zone of (n+1) parallaxes caused by the pixel group is generated and the deviation of the viewing zone is corrected. In the case where the number of parallaxes is nine, therefore, the viewing zone corresponding to one parallax becomes a zone where the disturbance image is originally recognized visually. Stated reversely, even if shaded pixels shown in FIG. 6 are subjected to processing, the original viewing zone is not sacrificed. When viewed from pixel groups having n pixels, however, a pixel group having (n+1) pixels is present both on the left side and the right side. If the left and right pixel groups having (n+1) pixels are subjected to the present processing, therefore, two parallaxes are dissipated in the image processing according to the present embodiment (FIG. 9). The occurrence frequency of a pixel group having (n+1) pixels is found from Equation (5). Denoting the number of pixel groups having n pixels disposed between pixel groups having (n+1) pixels by y, the zone subjected to the present image processing is held down to one parallax or less and the viewing zone is not sacrificed by satisfying the following equation.

1≦x≦1+y/2 (6)

Interpolation processing is performed in the pixel zone thus determined. It is desirable that the ratio of mixing other parallax information is high in R1 and L1 and it decreases as the pixel goes away from a pixel group having (n+1) pixels. Because a pixel is viewed further inside the viewing zone and more influence is exerted on a three-dimensional image viewed within the viewing zone as the pixel goes away from a pixel group having (n+1) pixels. As for the ratio of mixture, i.e., the method of interpolation, a conventional filter application method such as a bilinear method or a bi-cubic method should be applied.

### (Processing Using Tile Images)

Heretofore, an outline of image processing according to the present embodiment has been described by using an image (an array of pixel groups) at the time of three-dimensional image display. The image for three-dimensional image display is not suitable for compression. Because the image for three-dimensional image display is formed by arranging parallax information every pixel and parallax information is lost provided that the image is compressed by utilizing similarity between adjacent pixel information pieces. Generally, therefore, a format obtained by putting together the same parallax information is utilized for the image for compression. Since this format has a form in which parallax information pieces are arranged in a tile form, it is called tile images. Hereafter, the case where the image processing according to the present embodiment is performed on the tile images will be described.

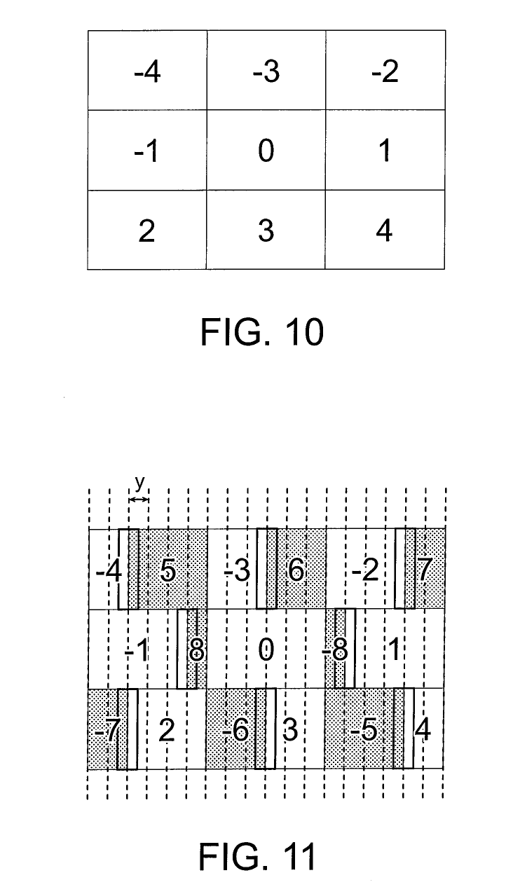

For the purpose of comparison, FIG. 10 shows an example of the tile images in the nine parallax multiview system or the II system which is not subjected to image processing according to the present embodiment. A nine parallax three-dimensional image in the multiview system means that nine two-dimensional images are changed over to be seen according to the horizontal movement of the viewing location as shown in FIGS. 4(a) to 4(j). The aspect of each parallax image is equal to the aspect of the display face. The number of constituent pixels in the tile images is equal to the number of pixels in the image for three-dimensional image display. Each parallax image corresponds to a multi-viewpoint image taken from a converging point of light rays generated at a distance L shown in FIG. 1 by taking the display face as a projection face. Even if compression or expansion processing is performed in the state of the tile images, image degradation occurs at tile boundaries. Therefore, image degradation at the time of three-dimensional image display concentrates to ends of the screen whereas a three-dimensional image in the center of the screen does not degrade. In the case of the II system which is not subjected to the image processing according to the present embodiment, a double image is viewed as described with reference to FIG. 5 (a viewing zone where a double image is not viewed is narrow).

FIG. 11 shows tile images of the nine parallax one-dimensional II system subjected to image processing according to the present embodiment. A method for generating tile images in the II system is described in JP-A 2006-098779 in detail. The II system is different from the multiview system in size (width) assigned the same parallax image number. Furthermore, the number of constituent parallax image number is also large (the parallax image number is −4 to 4 in the multiview system, whereas the parallax image number is −8 to 8 in the present embodiment).

First, it will now be described that the size (width) of the tile is not constant. It has been described in the description of the tile images in the multiview system that the tile images take a form obtained by putting together pixel information of the same parallax image number and each parallax image is an each-viewpoint image. In the II system, an orthographic projection image is used because light rays assigned the same parallax image information are parallel. Pixel groups having (n+1) pixels are generated discretely by the viewing zone optimization processing. As a result, parallax image numbers included in a pixel group change. The tile images can be generated by pulling out parallax images displayed on pixels at parallax number intervals. For example, in the multiview system shown FIGS. 2(a) and 2(b), every pixel group is formed of nine pixels. If parallax image numbers are selected every nine pixels, therefore, all of the selected parallax image numbers become the same parallax image number. In the case of the II system according to the present embodiment, however, parallax image numbers selected every nine parallaxes at the time when pixels groups having (n+1) pixels are formed change from the original parallax image numbers by +n or −n. For example, in FIGS. 6(a) and 6(b), images having a parallax image number 5 (=−4+9) are displayed on pixels on which images having a parallax image number −4 have been displayed until the viewing zone optimization. Because of reflection thereof, therefore, the tile images also take a form obtained by combining viewpoint images located parallax number apart as shown in FIG. 11.

It is easy to perform the image processing according to the present embodiment on the tile images in the II system. Additional lines represented by dashed lines are drawn in FIG. 11. Pixels y between additional lines are equal to the number y of pixel groups which form an occurrence space between pixel groups each having (n+1) pixels at the time of display of a three-dimensional image. A pixel is taken as the unit in the tile images, whereas counting is performed by taking a pixel group as the unit in the image for three-dimensional display. When performing interpolation processing according to the present embodiment, the processing should be performed around a place where the parallax image number has changed over. Therefore, the interpolation processing of mutually mixing adjacent parallax image information pieces at a constant ratio should be performed on a zone having a width y (y/2 for a parallax image on one side) represented by a thick frame centering around a pixel boundary shown in FIG. 11. The width y to be subjected to the processing follows Equation (7). When y=2, it is meant that the interpolation processing is performed on pixels located at both ends of a pixel group having (n+1) pixels in the image for three-dimensional image display.

### (Optimization)

Finally, if x is set to be x=y/2 in Equation (7), the viewing zone is sacrificed by one parallax. If x is set to be x=y/3, however, it is possible to prevent occurrence of a strap-shaped disturbance image sacrificing the viewing zone by only 0.66 parallax. In other words, an impression of a widened viewing zone is given. On the other hand, if x is too small, the strap-shaped disturbance image cannot be mitigated in some images. In other words, a more effective processing application range is represented by Equation (7).

y/4≦x≦y/3 (7)

In the case of the one-dimensional II system, the interpolation processing according to the present embodiment is effective even in a uni-direction (horizontal direction). If interpolation processing is performed in the perpendicular direction as well, the strap-shaped disturbance image can be further mitigated. Although already described, it is preferable for implementing a wider viewing zone to continuously change the ratio of mixture, centering on the boundary line.

Contents represented as a pixel in the description may be interpreted as a sub-pixel. Because each pixel can be formed of an RGB triplet and consequently directions of light rays which can be reproduced can be increased, i.e., a three-dimensional image having a higher definition can be displayed by displaying parallax image information with a sub-pixel pitch. Only the horizontal direction has been described and shown in the drawings. In the case where parallax information is also presented in the vertical direction perpendicular to the horizontal direction (as in, for example, the two-dimensional II system using a microlens array), the method described in the present embodiment can be applied to the vertical direction as it is.

### EXAMPLES

Hereafter, image processing according to the present embodiment will be described as examples.

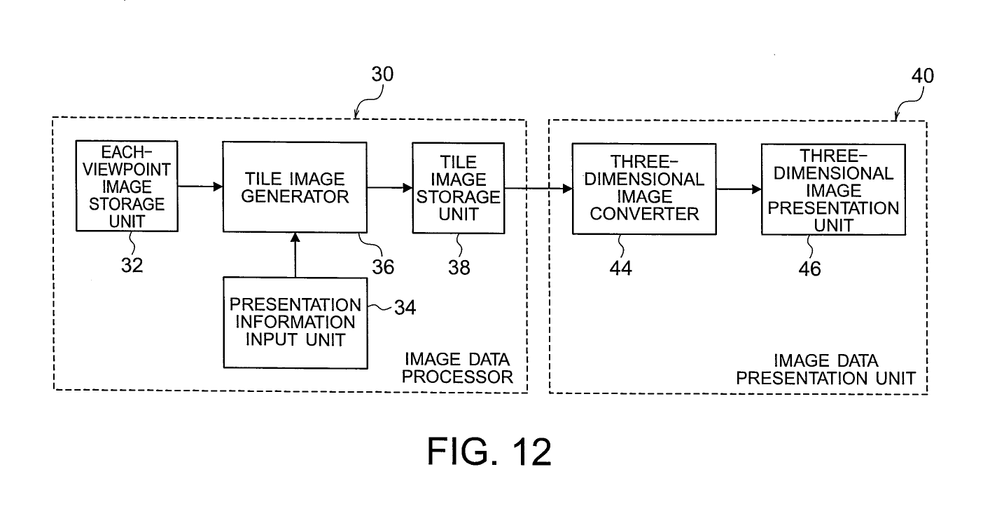

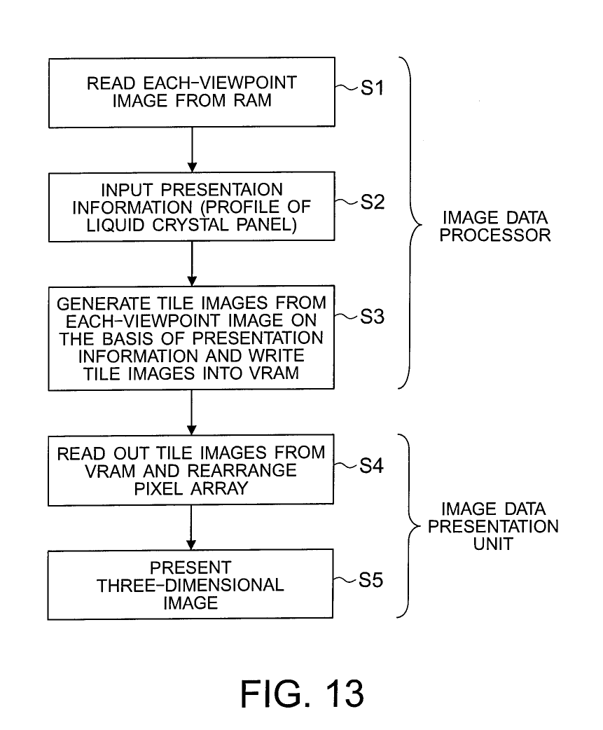

First, a general configuration of image data processing in a stereoscopic image display apparatus of the II system is shown in FIG. 12, and an image processing procedure is shown in FIG. 13. As already described, the stereoscopic image display apparatus of the II system includes the plane display device and the exit pupils (see, for example, FIG. 7(a)). The plane display device is, for example, a liquid crystal display device and includes a plane image display having pixels arranged in the length direction and the breadth direction in a matrix form. The exit pupils are called optical plates as well, and disposed so as to be opposed to the plane image display to control light rays emitted from the pixels. As shown in FIG. 12, the stereoscopic image display apparatus further includes an image data processor 30 and an image data presentation unit 40 in order to process image data.

The image data processor 30 includes an each-viewpoint image storage unit 32, a presentation information input unit 34, a tile image generator 36, and a tile image storage unit 38. The image data presentation unit 40 includes a three-dimensional image converter 44 and a three-dimensional image presentation unit 46. The three-dimensional image presentation unit 46 is the plane image display in the plane display device and exit pupils.

For example, an acquired or given each-viewpoint image is stored in the each-viewpoint image storage unit 32 using a RAM. On the other hand, specifications of the stereoscopic image display apparatus (such as the pitch A of the exit pupils, a sub-pixel pitch Pp, the number of pixels in the plane image display, and an air conversion focal distance of the exit pupils and pixels for the plane image display) are stored in the presentation information input unit 34. The tile image generator 36 reads the each-viewpoint image from the each-viewpoint image storage unit 32 and reads information in the presentation information input unit 34 (steps S1 and S2 in FIG. 13). Thereupon, tile images are generated by the tile image generator 36, and the generated tile images are stored in the tile image storage unit 38 using, for example, a VRAM (step S3 in FIG. 13). Processing in the image data processor 30 is performed to this point. The tile images read out from the tile image storage unit 38 are rearranged in the three-dimensional image converter 44 in the image data presentation unit 40 to generate images for three-dimensional image display (step S4 in FIG. 13). The generated images for three-dimensional image display are displayed in the three-dimensional image presentation unit 46 (step S5 in FIG. 13). Typically, the image data processor 30 is formed of, for example, a PC, and the image data presentation unit 40 is the plane image display in the plane display device and exit pupils. Processing performed in the three-dimensional image converter 44 is processing of rearranging pixel unit information by taking a sub-pixel as the unit, besides rearranging each-viewpoint image information pieces which are constituents of each-viewpoint image every lens. The reason is as follows: each-viewpoint image takes a pixel formed of three sub-pixels as the unit, whereas in the image for three-dimensional image display parallax images are disposed with a sub-pixel pitch. It is possible to prevent the processing speed from lowering by executing the rearrangement with a sub-pixel taken as the unit in the three-dimensional image converter 44.

### First Example

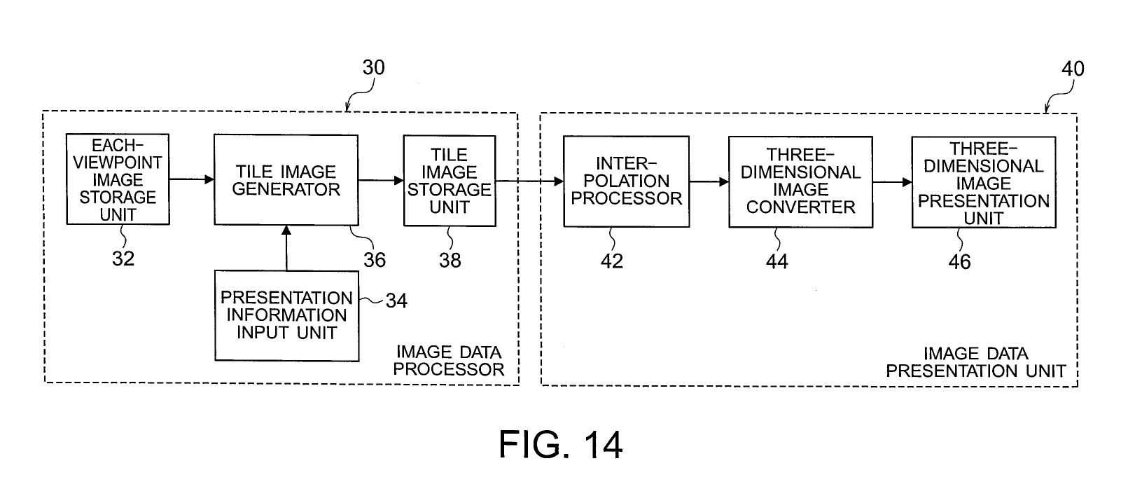

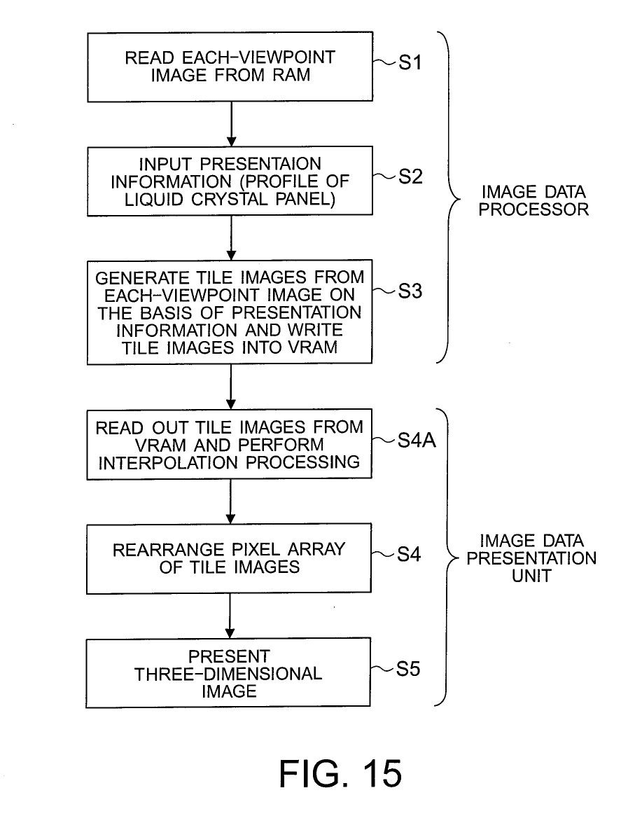

Image processing performed in a stereoscopic image display apparatus according to a first example of the present invention will now be described with reference to FIGS. 14 and 15. FIG. 14 is a block diagram showing a configuration of image data processing performed in the stereoscopic image display apparatus according to the first example. FIG. 15 is a flow chart showing its image processing procedure.

As shown in FIG. 14, the stereoscopic image display apparatus according to the present example includes an image data processor 30 and an image data presentation unit 40. The image data processor 30 includes an each-viewpoint image storage unit 32, a presentation information input unit 34, a tile image generator 36, and a tile image storage unit 38. The image data presentation unit 40 includes an interpolation processor 42, a three-dimensional image converter 44 and a three-dimensional image presentation unit 46. In other words, the present example has a configuration obtained by newly providing the interpolation processor 42 in the image data processing shown in FIG. 12, i.e., a configuration obtained by newly providing a step S4A for performing interpolation processing in the flow chart shown in FIG. 13 (FIG. 14 and FIG. 15). The interpolation processor 42 performs interpolation processing on the tile images read out from the tile image storage unit, for example, on boundary parts shown in FIG. 11. Thereafter, rearrangement processing of pixel arrangement is performed in the three-dimensional image converter 44.

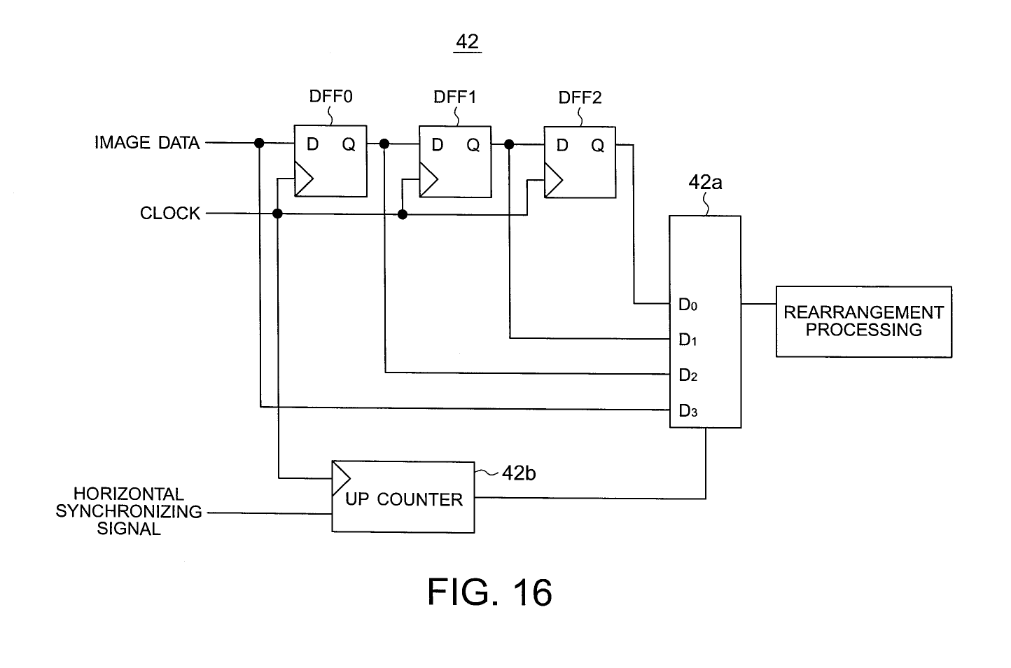

Operation of the interpolation processor 42 will be described more concretely. A configuration of the interpolation processor 42 which performs interpolation processing at tile boundaries prior to rearrangement of image information by taking a sub-pixel as the unit performed in the three-dimensional image converter 44 is shown in FIG. 16. The interpolation processor 42 includes a processor 42a which executes the bilinear method or the bi-cubic method and a part (such as a memory) which stores at least as many image data as the number of image data referred to in the interpolation processor 42 minus one. FIG. 16 shows a configuration for referencing four kinds of image data and performing interpolation processing in the processor 42a.

The part which stores image data uses three D-type flip-flops DFF0, DFF1 and DFF2 connected in series. By connecting the three D-type flip-flops DFF0, DFF1 and DFF2 in series, the image data is shifted from DFF0 to DFF1 and then to DFF2 in synchronism with a clock. As a result, it is possible to refer to four kinds: input image data (fourth data D3), output data of the DFF0 (third data D2), output data of the DFF1 (second data D1) and output data of the DFF2 (first data D0). For example, if it is necessary, when generating new second data (D1′), to refer to immediately preceding data (D0), the pertinent data (D1), immediately succeeding data (D2) and immediately succeeding data but one (D3), the new second data (D1′) can be generated without excess or shortage by using this configuration. If the number of data which should be referred to when generating new data is eight, it is a matter of course that the number of flip-flops DFF connected in series should be seven in a similar configuration. Since the number of the flip-flops DFF which is one less than the number of data referred to is the least number, the number of the flip-flops DFF may be equal to at least the number of data referred to. The processor 42a performs the interpolation processing by using these data and then the three-dimensional image converter 44 performs the rearrangement processing.

As shown in FIG. 11, similar interpolation processing is not performed on all image data, but there are also image data which are not subjected to the interpolation processing at all. In other words, contents of the interpolation processing differ according to the order (location) of the input image data. In order to perform the different processing contents on image data in correct locations, means for referring to locations of input data also becomes necessary. In the configuration shown in FIG. 16, an up counter 42b is used as means for referring to the location of input data. If this up counter 42b is activated in synchronism with a horizontal synchronizing signal, referring to the data location can be performed simply.

In the case where the interpolation processing is executed after image information is rearranged by taking a sub-pixel as the unit, i.e., in the case where the interpolation processor 42 is provided after the three-dimensional image converter 44 shown in FIG. 14 (in the case where the interpolation processing is performed after the pixel array of the tile images is rearranged in the flow chart shown in FIG. 15), data referred to are not in the time series order. Therefore, the number of means for retaining the data referred to, for example, the number of DFFs becomes larger as compared with the case where the interpolation processing is executed before image information is rearranged by taking a sub-pixel as the unit.

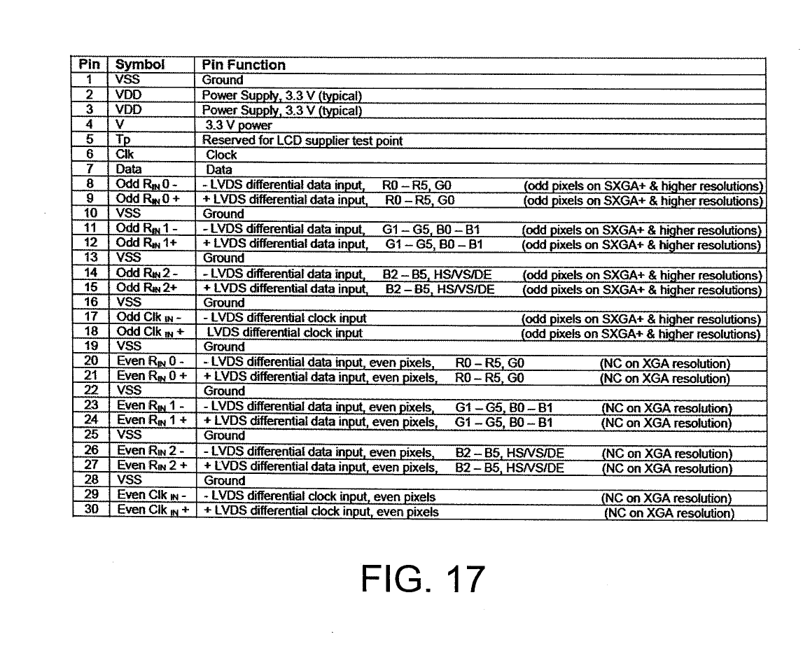

In some cases, contents of utilized interpolation processing differ depending upon characteristics of the three-dimensional image display apparatus. Therefore, it is necessary to have means which determines processing contents to be utilized. If a programmable logic device is used, it can be coped with by rewriting the processing contents every panel. If an unrewritable device such as ASIC is used, however, such coping cannot be performed. Therefore, there is a method of preparing processing contents scheduled to be utilized beforehand and selecting processing contents every panel characteristics recorded in the presentation information input unit 34. As for this selection method, there are various methods and utilization of a switch and resistors is well known means. Unlike their methods, there is also a method of selecting from an image output device (such as a PC). FIG. 17 shows a pin assignment of an LVDS connector used widely as the signal input means of the liquid crystal panel (SPWG Notebook Panel Specification Version 3.0 published by The Standard Panels Working Group (SPWG)). Among thirty pins, a pin number 4 (EDID V), a pin number 5 (TP), a pin number 6 (EDID CLOCK) and a pin number 7 (EDID DATA) are assigned to signals which have no relation to image data or control signals (the vertical synchronizing signal, the horizontal synchronizing signal, and data enable), and they are not used in many cases. If the four pins in total are utilized, therefore, it becomes possible to make a selection from a maximum of 16 kinds of processing contents according to information of the presentation information input unit.

### Second Example

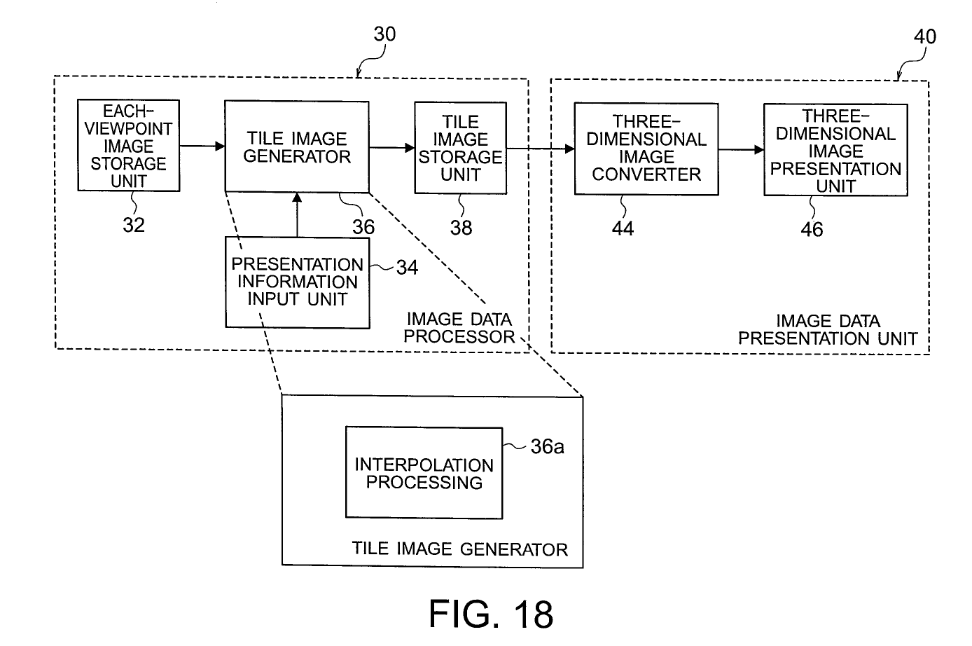

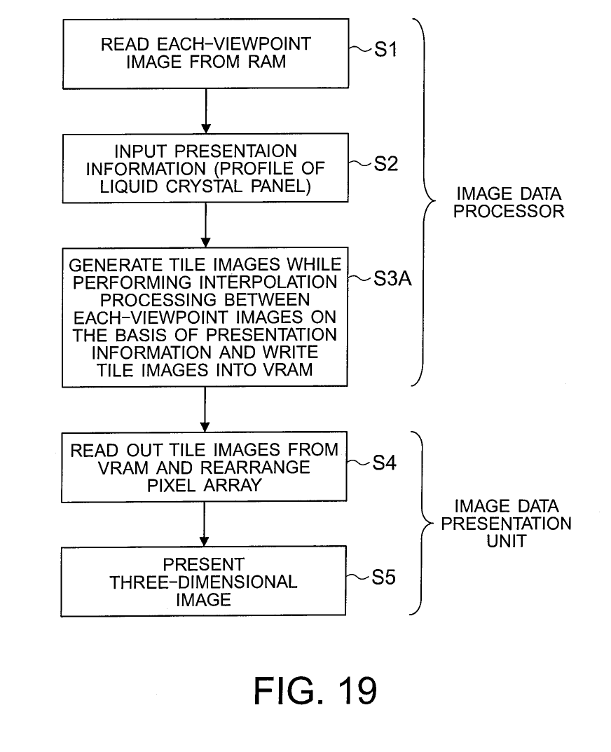

Image processing performed in a stereoscopic image display apparatus according to a second example of the present invention will now be described with reference to FIGS. 18 and 19. FIG. 18 is a block diagram showing a configuration of image data processing performed in the stereoscopic image display apparatus according to the second example. FIG. 19 is a flow chart showing its image processing procedure.

As shown in FIG. 18, the stereoscopic image display apparatus according to the present example has a configuration in which interpolation processing is performed in the tile image generator 36 in the image data processor 30. In other words, in the flow chart shown in FIG. 15, the step S3 and the step S4A are merged, and tile images are generated while performing the interpolation processing between each viewpoint images on the basis of each-viewpoint image and written into the tile image storage unit 38.

An interpolation processor 36a is provided in the tile image generator 36 in the image data processor 30. As a result, it is possible to directly generate tile images subjected to the interpolation processing in the boundary parts shown in FIG. 11 on the basis of the each-viewpoint image read out from the each-viewpoint image storage unit 32 and a profile of the liquid crystal panel, and write the tile images into the tile image storage unit 38. The tile images read out from the tile image storage unit 38 are rearranged in the three-dimensional image converter 44 in the image data presentation unit 40 to generate an image for three-dimensional image display (step S4 in FIG. 19). The generated image for three-dimensional image display is displayed in the three-dimensional image presentation unit 46 (step S5 in FIG. 19).

### Third Example

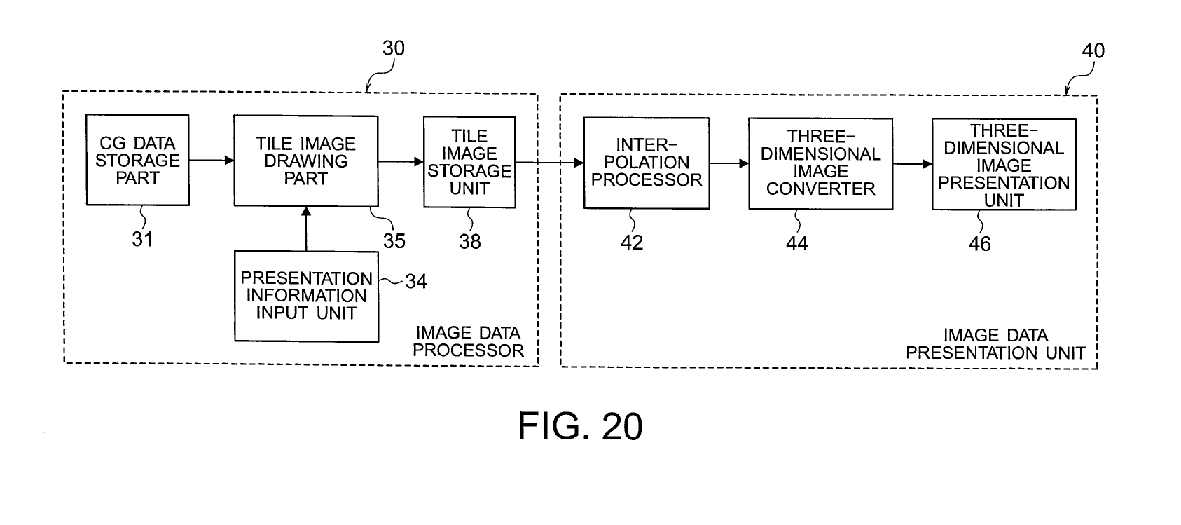

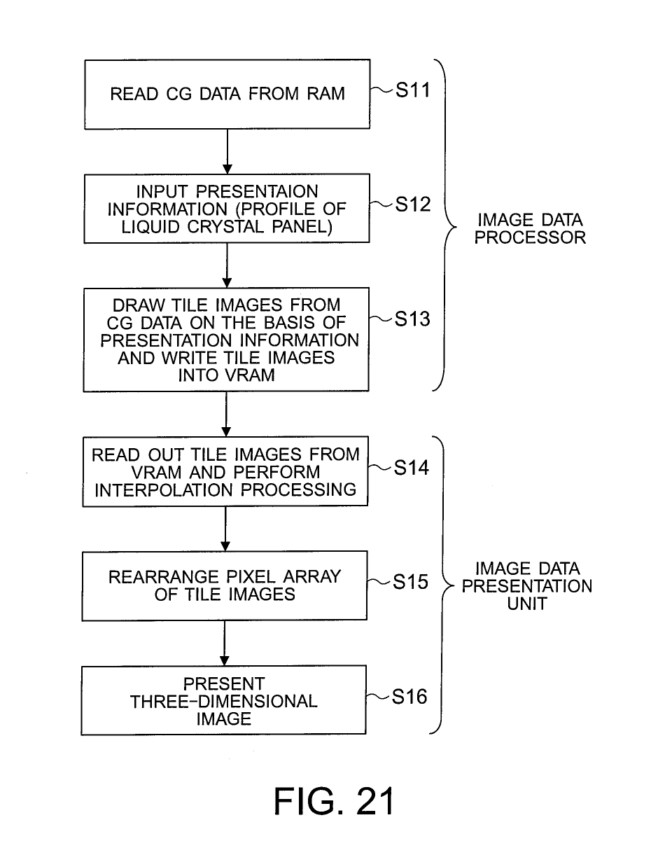

Image processing performed in a stereoscopic image display apparatus according to a third example of the present invention will now be described with reference to FIGS. 20 and 21. FIG. 20 is a block diagram showing a configuration of image data processing performed in the stereoscopic image display apparatus according to the third example. FIG. 21 is a flow chart showing its image processing procedure.

The stereoscopic image display apparatus according to the present example performs image data processing at the time of real time drawing by using computer graphics (hereafter referred to as CG as well). As shown in FIG. 20, the stereoscopic image display apparatus according to the present example includes an image data processor 30 and an image data presentation unit 40. The image data processor 30 includes a CG data storage part 31, a presentation information input unit 34, a tile image drawing part 35 and a tile image storage unit 38. The image data presentation unit 40 includes an interpolation processor 42, a three-dimensional image converter 44 and a three-dimensional image presentation unit 46.

The processing procedure will now be described. First, CG data generated by using CG are stored in the CG data storage part 31 using, for example, a RAM (step S11 in FIG. 21). Here, the CG data are various data required to draw CG, such as a polygon or a texture. Tile images are generated in the tile image drawing part 35 on the basis of the CG data read out from the CG data storage part 31 and the profile of the liquid crystal panel input from the presentation information input unit 34 (steps S12 and S13 in FIG. 21). The generated tile images are written into, for example, the tile image storage unit 38 (step S13). The tile images read out from the tile image storage unit 38 are subjected to interpolation processing in the interpolation processor 42 provided in the image data presentation unit 40 (step S14). The image data subjected to the interpolation processing are rearranged in the three-dimensional image converter 44 to generate an image for three-dimensional image display (step S15). The generated image for three-dimensional image display is displayed in the three-dimensional image presentation unit 46 (step S16).

According to the present example having such a configuration, it is possible to reduce the processing load of the image data processor and improve the refresh rate.

### Fourth Example

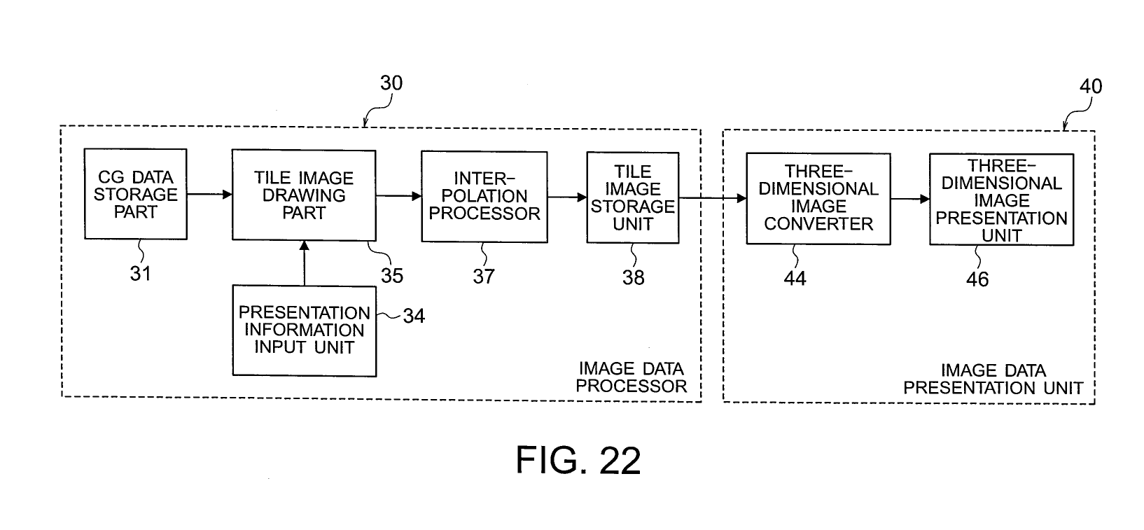

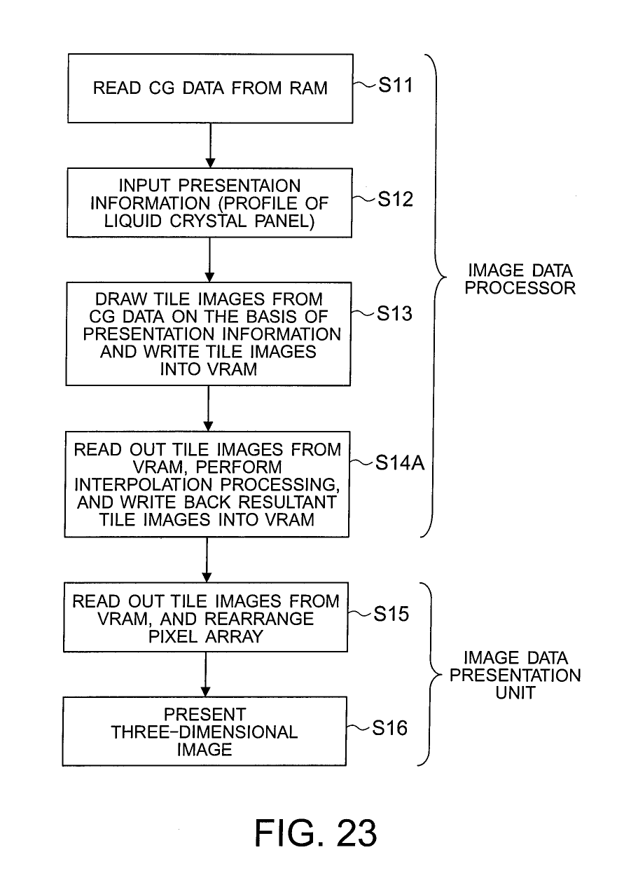

Image processing performed in a stereoscopic image display apparatus according to a fourth example of the present invention will now be described with reference to FIGS. 22 and 23. FIG. 22 is a block diagram showing a configuration of image data processing performed in the stereoscopic image display apparatus according to the fourth example. FIG. 23 is a flow chart showing its image processing procedure.

The image data processing performed in the stereoscopic image display apparatus according to the present example is processing at the time of real time drawing unlike that according to the third example.

As shown in FIG. 22, the image data processing in the stereoscopic image display apparatus according to the present example is performed after the processing in the tile image drawing part 35 in the image data processor 30. In other words, in the flow chart shown in FIG. 21, the step S14 is replaced with a step S14A. After the tile images are read out from the tile image drawing part 35 and subjected to the interpolation processing, resultant tile images are written into the tile image storage unit 38. The tile images read out from the tile image storage unit 38 are rearranged in the three-dimensional image converter 44 to generate an image for three-dimensional image display (step S15). The generated image for three-dimensional image display is displayed in the three-dimensional image presentation unit 46 (step S16).

In the present example in which all interpolation processing is performed in the image data processor 30, versatility capable of coping with a change of the image data presentation unit 40 can be ensured.

### Fifth Example

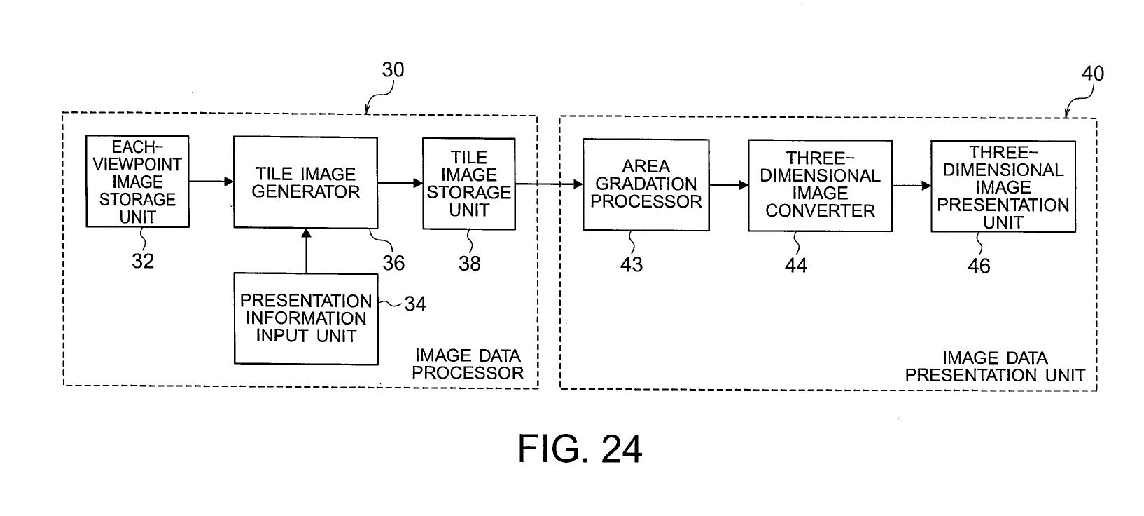

As the interpolation method described with reference to the first example to the fourth example, there are the bilinear method and the bi-cubic method. However, the well-known area gradation processing may be used. In this case, similar effects can be obtained without performing the interpolation processing. In other words, a memory zone required to perform the interpolation can be reduced by replacing the interpolation processor shown in FIGS. 14, 18, 20 and 22 with an area gradation processor. For example, in the first example shown in FIG. 14, the interpolation processor 42 should be replaced with an area gradation processor 43 (see FIG. 24).

According to an embodiment of the present invention, it is possible to mitigate appearance of the strap-shaped disturbance image and shift to the side lobe naturally as heretofore described. As a result, it becomes possible to improve the display definition of the three-dimensional image remarkably.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

1. A three-dimensional image display method for displaying a three-dimensional image on a display apparatus including a plane image display having pixels arranged in a matrix form, and an optical plate disposed so as to be opposed to the plane image display, the optical plate having exit pupils arranged in at least one direction to control light arrays from the pixels, the method comprising:
generating an image for three-dimensional image display in which a plurality of pixels in the plane image display are associated as one of pixel groups with each exit pupil;
setting each of the pixel groups to either a first pixel group which is n (where n is a natural number of at least 2) in the number of pixels in one direction of the pixel group or a second pixel group which is (n+1) in the number of pixels in one direction of the pixel group;
disposing the second pixel groups between the first pixel groups discretely and at substantially constant intervals; and
performing interpolation processing to mutually mix parallax information pieces of pixels located at both ends of the second pixel groups.

2. The method according to claim 1, further comprising:
performing interpolation processing to mix a parallax image of a pixel which is included in two of the first pixel groups adjacent to the each of the second pixel group and which is farthest from the second pixel group, and a parallax image of a pixel in a pixel group which is adjacent to the pixel and which is different from the first pixel groups, wherein
a ratio of mixture of parallax information at pixels located at both ends of the second pixel group is made the highest, and
a ratio of mixture of a parallax image at a pixel which is in the first pixel groups and which is farthest from the second pixel group is decreased as the pixel goes away from the second pixel group.

3. The method according to claim 2, wherein the number of the first pixel groups to be subjected to processing of mixing parallax information is equal to or less than half of a total number of the first pixel groups located between the second pixel groups.

4. The method according to claim 1, comprising:
putting together the images for three-dimensional image display every same parallax image number and generating tile-shaped tile images; wherein
the interpolation processing is performed centering on a boundary between adjacent tile images having different parallax image numbers.

5. The method according to claim 4, wherein the interpolation processing is performed in a software manner when generating the tile images.

6. The method according to claim 1, wherein the interpolation processing is performed in a software manner or in a circuit manner when generating the image for three-dimensional image display.

7. The method according to claim 5, wherein the interpolation processing is performed in an area gradation manner.

8. A three-dimensional image display apparatus including:
a plane image display having pixels arranged in a matrix form;
an optical plate disposed so as to be opposed to the plane image display, the optical plate having exit pupils arranged in at least one direction to control light arrays from the pixels, a plurality of pixels in the plane image display being associated as one of pixel groups with each exit pupil;
a setting unit setting each of the pixel groups to either a first pixel group which is n (where n is a natural number of at least 2) in the number of pixels in one direction of the pixel group or a second pixel group which is (n+1) in the number of pixels in one direction of the pixel group;
a disposition unit disposing the second pixel groups between the first pixel groups discretely and at substantially constant intervals; and
an interpolation processor performing interpolation processing to mutually mix parallax information pieces of pixels located at both ends of the second pixel groups.

9. The apparatus according to claim 8, wherein the interpolation processor mixes a parallax image of a pixel which is included in two of the first pixel groups adjacent to the each of the second pixel group and which is farthest from the second pixel group, and a parallax image of a pixel in a pixel group which is adjacent to the pixel and which is different from the first pixel groups, so that a ratio of mixture of parallax information at pixels located at both ends of the second pixel group is made the highest, and a ratio of mixture of a parallax image at a pixel which is in the first pixel groups and which is farthest from the second pixel group is decreased as the pixel goes away from the second pixel group.

10. The apparatus according to claim 9, wherein the number of the first pixel groups to be subjected to processing of mixing parallax information is equal to or less than half of a total number of the first pixel groups located between the second pixel groups.

11. The apparatus according to claim 8, further comprising:
a tile image generator putting together the images for three-dimensional image display every same parallax image number and generating tile-shaped tile images, wherein
the interpolation processor performs the interpolation processing as a center on a boundary between adjacent tile images having different parallax image numbers.

12. The apparatus according to claim 11, wherein the interpolation processing is performed in a software manner when generating the tile images.

13. The apparatus according to claim 8, wherein the interpolation processing is performed in a software manner or in a circuit manner when generating the image for three-dimensional image display.

14. The method according to claim 12, wherein the interpolation processing is performed in an area gradation manner.
